(19) United States
(12) Patent Application Publication
(10) Pub. No.: US 2026/0238801 A1
(43) Pub. Date: Aug. 13, 2026

(54) A METHOD AND APPARATUS FOR SELF-CONTAINED TRANSPARENCY INFORMATION CARRIAGE

(71) Applicant: InterDigital CE Patent Holdings, SAS, Paris (FR)

(72) Inventors: Serge DEFRANCE, RENNES (FR); Franck THUDOR, RENNES (FR); Patrice HIRTZLIN, BETTON (FR); Etienne FAIVRE D'ARCIER, SAINT GONLAY (FR)

(21) Appl. No.: 19/153,802

(22) PCT Filed: Jan. 29, 2024
(86) PCT No.: PCT/EP2024/052107

§ 371 Date: Aug. 5, 2025

(30) Foreign Application Priority Data
Feb. 6, 2023 (EP) 23305154.9

(51) Int. Cl. H04N 19/186; H04N 19/172; H04N 19/70

(52) U.S. Cl. CPC H04N 19/186; H04N 19/172; H04N 19/70

(57) ABSTRACT

Methods, devices and data streams are proposed to change the transparency color on an image basis and transmit this information within the image. It is based on the fact that the useful information of a rectangle image with transparency is located in the center of the rectangle and on that a part of the fringe of the image, typically one of the four corners, is always transparent and can be used to transmit the transparency color for each image. The transparency color is coded on two components and the third component is used to transmit the transparency information. Possible color spaces for the representation of the image which separate luminance and chrominance information, as CEI XYZ or CEI xyY color spaces.

### CROSS REFERENCE TO RELATED APPLICATIONS

This application claims the benefit of European Application No. 23305154.9, filed on Feb. 6, 2023, which is incorporated herein by reference in its entirety.

### 1. TECHNICAL FIELD

The present principles generally relate to the encoding of a transparency component in an image. The present document is also understood in the context of the encoding, the formatting and the decoding of images meant to be overlaid to another image, for example in the context of immersive applications.

### 2. BACKGROUND

The present section is intended to introduce the reader to various aspects of art, which may be related to various aspects of the present principles that are described and/or claimed below. This discussion is believed to be helpful in providing the reader with background information to facilitate a better understanding of the various aspects of the present principles. Accordingly, it should be understood that these statements are to be read in this light, and not as admissions of prior art.

Recently there has been a growth of available large field-of-view content (up to 360°). Such content is potentially not fully visible by a user watching the content on immersive display devices such as Head Mounted Displays, smart glasses, PC screens, tablets, smartphones and the like. That means that at a given moment, a user may only be viewing a part of the content. However, a user can typically navigate within the content by various means such as head movement, mouse movement, touch screen, voice and the like. It is typically desirable to encode and decode this content.

The overlay of a picture or video over another one is a capability which is even more used for example in the development of Augmented Reality (AR) applications. This is also the case for the overlay of a picture or a video onto the real word via AR glasses. However, the overlay is not a full picture but only part of it, the other pixels of the picture being transparent are not rendered and partially transparent (for instance in case of a shadow effect) are rendered in a transparent way. Many technical solutions exist to carry transparency information. The chroma key compositing has been used for decades. This technique consists in reserving a color (for example green or blue, because the human skin colors comprise very few green or blue) to indicate a binary information: transparent or not. For proper overlay in an AR context, more precise information is required, in order to be able to modulate the transparency information between 0% to 100% and being able to realize shadow effects. Transparency information may be encoded in an alpha channel. Various techniques are possible for carrying an alpha channel. It may be directly inserted in the video codec information as an auxiliary picture. Codecs standards like AVC or HEVC describe the method for carrying an associated auxiliary picture which contains transparency information. ISOBMFF_based formats, which are solutions to multiplex multimedia streams, also describe specific solutions for including an alpha channel in the multimedia stream. A Scene Description language, which implements a high-level AR scene description signaling, makes possible to describe how to use the transparency information when it is provided either by the decoder or the multimedia stream demultiplexer.

There is a lack for a method for carrying self-contained transparency information in the video and compatible with any coding/decoding system.

### 3. SUMMARY

The following presents a simplified summary of the present principles to provide a basic understanding of some aspects of the present principles. This summary is not an extensive overview of the present principles. It is not intended to identify key or critical elements of the present principles. The following summary merely presents some aspects of the present principles in a simplified form as a prelude to the more detailed description provided below.

The present principles relate a method comprising obtaining a first image using color format comprising a transparency component. A code color value that is unused in the first image is selected. A second image using color format encoding chrominance on two components and luminance on one component is generated. A code block is detected in the first image, the code block being a fully transparent block. Then, a block of the second image corresponding to the code block is filled with the code color value with a luminance set to zero and for each pixel of the first image, when the pixel is transparent, the method comprises filling the corresponding pixel of the second image with the code color value and a level of luminance corresponding to the transparency component of the pixel; and when the pixel is opaque, filling the corresponding pixel of the second image with the color value of the pixel. The resulting second image is encoded in a data stream.

The present principles also relate to a device comprising a memory associated with a processor configured for implementing the method above.

The present principles also relate a method comprising obtaining a first image using color format encoding chrominance on two components and luminance on one component. A block of the first image that comprise a unique code chrominance with a luminance set to zero is detected. A second image of a same size or bigger than the first image is obtained. The second image may be a background image. The first image is to be rendered in the second image. So a pixel of the second image is selected to correspond to one of the corners of the first image. Then, for each pixel of the first image, when the pixel stores the color chrominance, the method comprises rendering a default chrominance on a corresponding pixel of the second image with a transparency relative to the luminance of the pixel; otherwise rendering the color value of the pixel on a corresponding pixel of the second image. The second image may be displayed.

The present principles also relate to a device comprising a memory associated with a processor configured for implementing the method above.

### 4. BRIEF DESCRIPTION OF DRAWINGS

The present disclosure will be better understood, and other specific features and advantages will emerge upon reading the following description, the description making reference to the annexed drawings wherein:

FIG. 1 shows a diagram of a system handling images with transparency;

FIG. 2 shows an image that comprises at least one fully transparent block according to the present principles;

FIG. 3 shows an example architecture of a device which may be configured to implement a method described in relation with FIGS. 5 and 6;

FIG. 4 shows an example of an embodiment of the syntax of a stream when the data are transmitted over a packet-based transmission protocol;

FIG. 5 illustrates a method to encode transparency in an image in a format that does not comprise a transparency component, according to a non-limiting embodiment of the present principles;

FIG. 6 illustrates a method to render an image with transparency from an image in a format that does not comprise a transparency component, according to a non-limiting embodiment of the present principles.

### 5. DETAILED DESCRIPTION OF EMBODIMENTS

The present principles will be described more fully hereinafter with reference to the accompanying figures, in which examples of the present principles are shown. The present principles may, however, be embodied in many alternate forms and should not be construed as limited to the examples set forth herein. Accordingly, while the present principles are susceptible to various modifications and alternative forms, specific examples thereof are shown by way of examples in the drawings and will herein be described in detail. It should be understood, however, that there is no intent to limit the present principles to the particular forms disclosed, but on the contrary, the disclosure is to cover all modifications, equivalents, and alternatives falling within the spirit and scope of the present principles as defined by the claims.

The terminology used herein is for the purpose of describing particular examples only and is not intended to be limiting of the present principles. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to other element, there are no intervening elements present. As used herein the term “and/or” includes any and all combinations of one or more of the associated listed items and may be abbreviated as“/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the present principles.

Although some of the diagrams include arrows on communication paths to show a primary direction of communication, it is to be understood that communication may occur in the opposite direction to the depicted arrows.

Some examples are described with regard to block diagrams and operational flowcharts in which each block represents a circuit element, module, or portion of code which comprises one or more executable instructions for implementing the specified logical function(s). It should also be noted that in other implementations, the function(s) noted in the blocks may occur out of the order noted. For example, two blocks shown in succession may, in fact, be executed substantially concurrently or the blocks may sometimes be executed in the reverse order, depending on the functionality involved.

Reference herein to “in accordance with an example” or “in an example” means that a particular feature, structure, or characteristic described in connection with the example can be included in at least one implementation of the present principles. The appearances of the phrase in accordance with an example” or “in an example” in various places in the specification are not necessarily all referring to the same example, nor are separate or alternative examples necessarily mutually exclusive of other examples.

Reference numerals appearing in the claims are by way of illustration only and shall have no limiting effect on the scope of the claims. While not explicitly described, the present examples and variants may be employed in any combination or sub-combination.

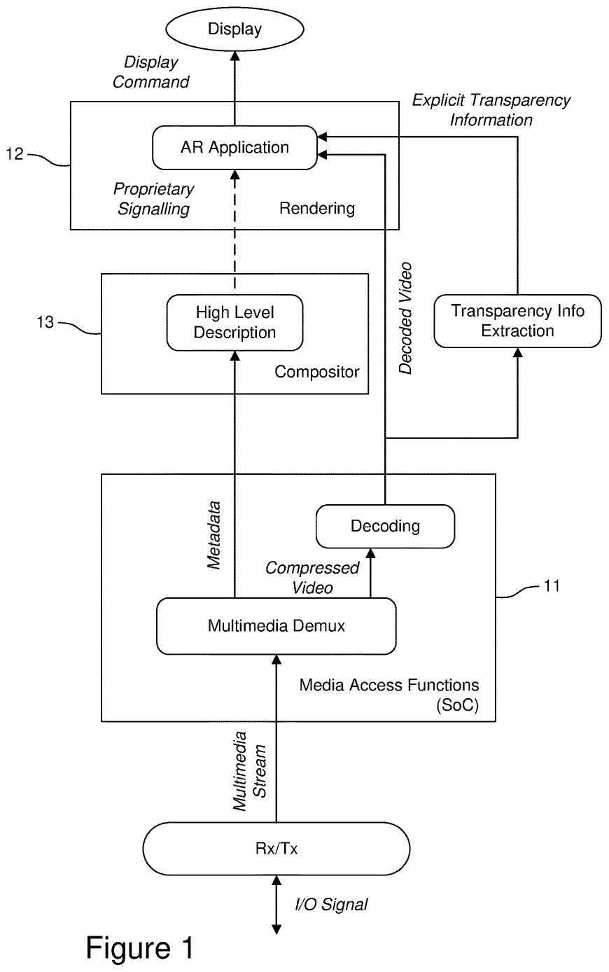

FIG. 1 shows a diagram of a system handling images with transparency. A media access functions 11 provides the transparency information obtained either from a multimedia demultiplexer, or from a decoder, depending on the implemented transparency carriage method. The multimedia demultiplexer also provides metadata which may contain information relative to the use of transparency information to a high-level description module. The multimedia stream is demultiplexed. If it contains an alpha channel, the decoder extracts it and forwards it to the rendering block 12. Then, the video stream is sent to the decoder. Metadata are interpreted by a compositor block 13 which is in charge of the coordination of the rendering of the various media. If additional information regarding the use of the transparency is present, it is sent to rendering block 12 which is in charge of driving the display. The rendering uses both transparency information (supposed to come from either the decoder or the multimedia demultiplexer) and optional additional information coming from the metadata through compositor 13.

Such a method is based on the assumptions that the decoding or demux functions can handle transparency information if present in the in-coming multimedia stream. This may not be the case. The demux and decoding functions are often implemented as a System On-a-Chip (SoC) which rarely implements the transparency information handling.

So, there is a lack for a method for carrying self-contained transparency information in the video and compatible with any coding/decoding system. According to the present principles, the transparency information is extracted by a specific transparency module.

The chroma key composition system is used to transmit binary information for each pixel of an image: 0% or 100% transparent. This system is self-contained in the image. However, such a method has drawbacks because it relies on a specific color (e.g. green), imposing not to use this color for the part of the image that is not transparent. In addition, it only transmits binary information, where transparency information may contain all the value between 0% and 100%.

On the first hand, the present principles allow to change the transparency color on an image basis and transmit this information (transparency color) within the image. Indeed, an image is a rectangle and useful information is located at the center of the rectangle. According to the present principles, a part of the image's fringe (for example one of the four corners) is considered as transparent and can be used to transmit the transparency color for each image. If necessary, a column or a row of transparent blocks can be added to the image. On the other hand, it is proposed to code the transparency color on two components of a color space (which has three components) and to reserve the third component for the transmission of a level of transparency. According to the present principles, a color space for the representation of the image is selected to encode the transparency information, for example YUV, HSV, CEI XYZ or CEI xyY color spaces.

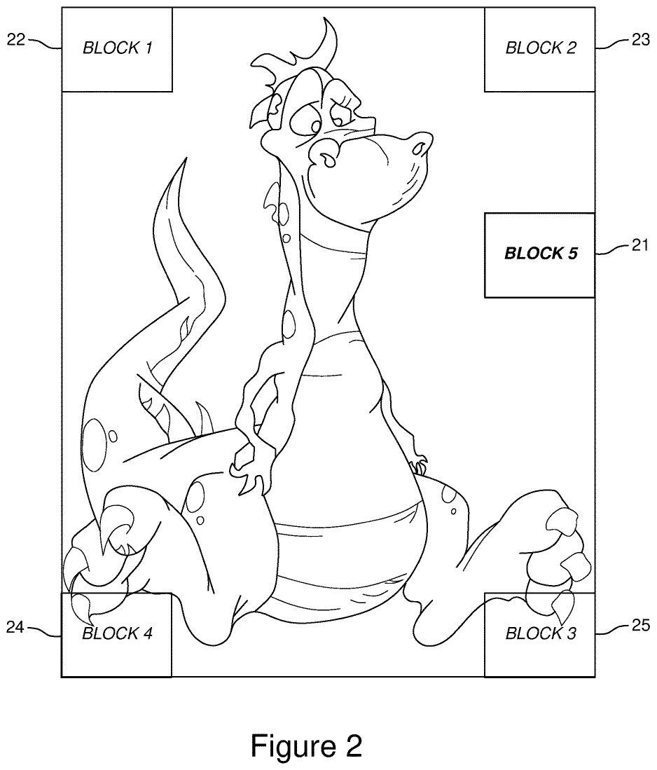

FIG. 2 shows an image that comprises at least one fully transparent block according to the present principles. A block is a rectangle within the image defined according to the compression mode for example. A block of pixels within an image is a well-known object in image processing. Such an image is meant to be overlayed on a background image, but only part of this image (i.e. the non-transparent part) is rendered. The resulting image has a rectangle format and is formed by the superimposition of a background rectangle and the considered image (representing a dragon in FIG. 2). The position of the dragon (i.e. the meaning part of the pixel information) within the rectangle is constrained. The rectangle may correspond to the field of view of a display device (for instance, AR glasses) and the expected position of the dragon within this field of view. In such an application, the dragon likely fills the center of the rectangle. According to the present principles, at least one of the blocks of the image to encode is fully transparent. The image is scanned, block by block to detect a fully transparent block 21. According to an embodiment of the present principles, one of the four corners 22 to 25 of the rectangle is fully transparent, and so, only the four corner blocks of the image are scanned to detect a fully transparent block. In the example of FIG. 2, blocks 21 to 23 are fully transparent when blocks 24 and 25 are not.

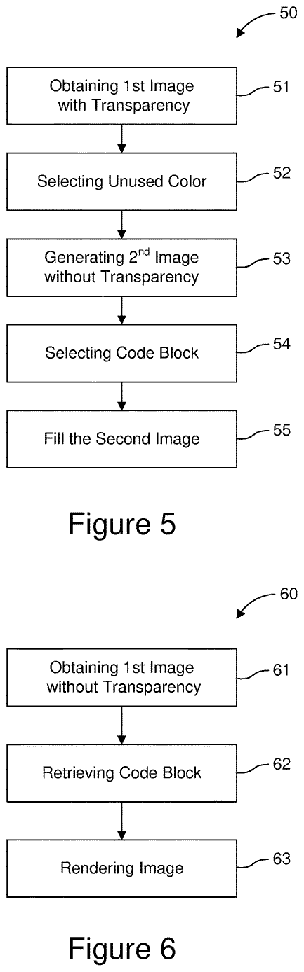

FIG. 5 illustrates a method 50 to encode transparency in an image in a format that does not comprise a transparency component. At a step 51, a first image encoded according to a format that comprises a three-dimensional color component and a transparency component is obtained, for example from a file or from a stream. The format may be, for instance RGBA or YUV plus Alpha. In RGB formats, the chrominance (i.e. the hue) is coded on three components and is mixed with the luminance. In YUV or CEI, for example, the chrominance is coded on two components and the luminance is encoded on a third component. A component is a number coded on a given number of bits, for example 6, 8, 10 or 12. At a step 52, the first image is analyzed to detect a color value that is unused for the opaque pixels of the first image. The selected color value will be referred as the code color value for this image. In an embodiment, the selected code color value is as far as possible in the three-dimensional (3D) color space from the color values used for opaque pixels of the first image. Indeed, in a 3D space like a 3D color space, it is possible to compute a distance between two points (two color values in the present case). So, it is possible to select a color value having a distance as far as possible from the average of the used color values. At a step 53, a second image of the same size is generated. The second image is encoded according to a color format encoding the chrominance on two components, the luminance on one component and with no transparency component. In a variant of step 53, the first image is converted to become the second image (that is, the color format of the first image is modified to obey the constraints of the color format of the second image). At a step 54, a block of the first image is selected to be the code block. A block is a rectangle area of the image, for example 8×8 or 16×16 pixels. This block is selected because it is fully transparent in the first image, so the color of the pixels is not used. In an embodiment, only the corner blocks (22 to 25 in FIG. 2) are tested. Indeed, they are the most likely blocks to be fully transparent. If no fully transparent block is detected, then a given block is selected, for example block 22 of FIG. 2, to be the code block. In another embodiment, a fully transparent row of blocks or column of blocks is added, so the first corner (block 22) is fully transparent. At a step 55, every pixel of the second image is filled with a color value determined according to the color value plus transparency of the corresponding pixel of the first image. According to the present principles, for a pixel of the first image, if the pixel is opaque (that is the transparency component of the pixel is set to 0 and, so, it is a used pixel), then, the color value of the pixel from the first image is copied in the corresponding pixel of the second image. If the transparency component pixel of the first image is greater than 0, then, the 2D chrominance component of the corresponding pixel of the second image is set to the code color value and the luminance component of the pixel is set to the transparency value of the pixel of the first image. As the code block is fully transparent, it is entirely filled with the code color. The second image is encoded in a file or in a stream as an image using a 3D color format with no transparency component. In a variant, metadata are encoded in the file or in the stream. These metadata may comprise an information indicating the location of the code block or the code color value.

FIG. 6 illustrates a method 60 to render an image with transparency from an image in a format that does not comprise a transparency component. At a step 61, a first image encoded with a 3D color format with no transparency component is obtained. The 3D color format encodes the chrominance on two components and the luminance on the third component. The first image may be obtained from a file or from a stream via a network, for example. At a step 62, the first image is analyzed to retrieve a block that is entirely filled with a unique code color value that has a given chrominance value and a luminance set to 0. Every pixel of the block stores the same code color value. In a variant, the location of the code block or the code color to search is indicated in metadata. At a step 63, the first image is rendered in a part of a second image. The second image has at least the same size than the first image. In a variant, the first image is resized to fit in a part of the second image before the rendering. The pixel at the upper corner of the first image corresponds to the pixel at the upper corner of the part of the second image. The second image may be a background image. At step 63, for each pixel of the first image, when the chrominance of the pixel equals the code color value, then the pixel is rendered on the corresponding pixel of the second image as a transparent pixel. If the luminance of the pixel of the first image indicates it is fully transparent, it is simply not rendered. If the luminance indicates it is partially transparent, a default hue (e.g. black or white or a grey) is rendered at the level of transparency indicated by the luminance (for example to render shadows) and overlaid to the corresponding pixel of the second image. When the chrominance of the pixel differs from the code color value, the pixel of the first image is overlaid to the corresponding pixel of the second image.

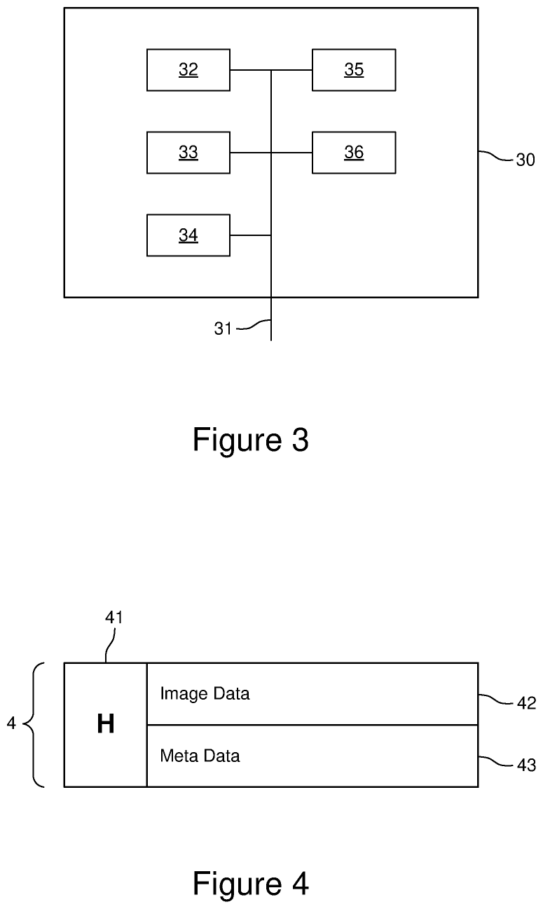

FIG. 3 shows an example architecture of a device 30 which may be configured to implement a method described in relation with FIGS. 5 and 6. The encoder and/or the decoder may implement this architecture. Alternatively, each circuit 11, 12 or 13 of FIG. 1 may be a device according to the architecture of FIG. 3, linked together, for instance, via their bus 31 and/or via I/O interface 36.

Device 30 comprises following elements that are linked together by a data and address bus 31:
a microprocessor 32 (or CPU), which is, for example, a DSP (or Digital Signal Processor);
a ROM (or Read Only Memory) 33;
a RAM (or Random Access Memory) 34;
a storage interface 35;
an I/O interface 36 for reception of data to transmit, from an application; and
a power supply, e.g. a battery.

In accordance with an example, the power supply is external to the device. In each of mentioned memory, the word «register» used in the specification may correspond to area of small capacity (some bits) or to very large area (e.g. a whole program or large amount of received or decoded data). The ROM 33 comprises at least a program and parameters. The ROM 33 may store algorithms and instructions to perform techniques in accordance with present principles. When switched on, the CPU 32 uploads the program in the RAM and executes the corresponding instructions.

The RAM 34 comprises, in a register, the program executed by the CPU 32 and uploaded after switch-on of the device 30, input data in a register, intermediate data in different states of the method in a register, and other variables used for the execution of the method in a register.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

In accordance with examples, the device 30 is configured to implement a method described in relation with FIGS. 5 and 6, and belongs to a set comprising:
a mobile device;
a communication device;
a game device;
a tablet (or tablet computer);
a laptop;
a still picture camera;
a video camera;
an encoding chip;
a server (e.g. a broadcast server, a video-on-demand server or a web server).

FIG. 4 shows an example of an embodiment of the syntax of a stream when the data are transmitted over a packet-based transmission protocol. FIG. 4 shows an example structure 4 of a volumetric video stream. The structure consists in a container which organizes the stream in independent elements of syntax. The structure may comprise a header part 41 which is a set of data common to every syntax element of the stream. For example, the header part comprises some of metadata about syntax elements, describing the nature and the role of each of them. The structure comprises a payload comprising an element of syntax 42 and at least one element of syntax 43. Syntax element 42 comprises data representative of the first image or of a sequence of first images. Images may have been compressed according to an image compression method or to a video compression method. Element of syntax 43 is a part of the payload of the data stream and may comprise metadata about how frames of element of syntax 42 are encoded, for instance an information indicating the location of the code block or the code color value.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, Smartphones, tablets, computers, mobile phones, portable/personal digital assistants (“PDAs”), and other devices that facilitate communication of information between end-users.

Implementations of the various processes and features described herein may be embodied in a variety of different equipment or applications, particularly, for example, equipment or applications associated with data encoding, data decoding, view generation, texture processing, and other processing of images and related texture information and/or depth information. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and other communication devices. As should be clear, the equipment may be mobile and even installed in a mobile vehicle.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette (“CD”), an optical disc (such as, for example, a DVD, often referred to as a digital versatile disc or a digital video disc), a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading the syntax of a described embodiment, or to carry as data the actual syntax-values written by a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

1. A method comprising:
obtaining a first image with a resolution and using color format comprising a transparency component;
selecting a code color value that is unused in the first image;
generating a second image at the resolution and using color format encoding chrominance on two components and luminance on one component;
detecting a code block in the first image, wherein the code block is a fully transparent block of pixels;
for each pixel of the first image, when the pixel is transparent, filling the corresponding pixel of the second image with a chrominance corresponding to the code color value and a luminance corresponding to the transparency component of the pixel; and when the pixel is opaque, filling the corresponding pixel of the second image with the color value of the pixel; and
encoding the second image in a data stream.

2. The method according to claim 1, wherein the first image has four corner blocks, and wherein only the four corner blocks of the first image are tested to detect the code block.

3. The method according to claim 1, wherein the code color value is selected as far as possible from the used color values.

4. The method according to claim 1, wherein the second image is the first image converted to use a color format with no transparency component.

5. The method according to claim 1, wherein the data stream comprises metadata indicating a location of the code block and/or the code color value.

6. The method according to claim 1, first comprising adding a fully transparent block row or a fully transparent block column to the first image, the code block being a corner block of the added block row or the added block column.

7. A device comprising a memory associated with a processor configured for:
obtaining a first image with a resolution and using color format comprising a transparency component;
selecting a code color value that is unused in the first image;
generating a second image at the resolution and using color format encoding chrominance on two components and luminance on one component;
detecting a code block in the first image, a wherein the code block is a fully transparent block of pixels;
for each pixel of the first image, when the pixel is transparent, filling the corresponding pixel of the second image with a chrominance corresponding to the code color value and a luminance corresponding to the transparency component of the pixel; and when the pixel is opaque, filling the corresponding pixel of the second image with the color value of the pixel; and
encoding the second image in a data stream.

8. The device according to claim 7, wherein the first image has four corner blocks, and wherein only the four corner blocks of the first image are tested to detect the code block.

9. The device according to claim 7, wherein the code color value is selected as far as possible from the used color values.

10. The device according to claim 7, wherein the second image is the first image converted to use a color format with no transparency component.

11. The device according to claim 7, wherein the data stream comprises metadata indicating location of the code block and/or the code color value.

12. The device according to claim 7, first comprising adding a fully transparent block row or a fully transparent block column to the first image, the code block being a corner block of the added block row or the added block column.

13. A method comprising:
obtaining a first image with a size and a resolution and using color format encoding chrominance on two components and luminance on one component;
detecting a code block of the first image that comprises a unique chrominance with a luminance set to zero;
obtaining a second image of the size and the resolution; and
for each pixel of the first image, when the pixel stores the unique chrominance of the code block, rendering a default chrominance on a corresponding pixel of the second image with a transparency relative to the luminance of the pixel; otherwise rendering a color value of the pixel on a corresponding pixel of the second image.

14. The method of claim 13, wherein a location of the code block or the unique chrominance of the code block is indicated in metadata associated with the first image.

15. A device comprising a memory associated with a processor configured for:
obtaining a first image with a size and a resolution and using color format encoding chrominance on two components and luminance on one component;
detecting a code block of the first image that comprises a unique chrominance with a luminance set to zero;
obtaining a second image of the size and the resolution; and
for each pixel of the first image, when the pixel stores the unique chrominance of the code block, rendering a default chrominance on a corresponding pixel of the second image with a transparency relative to the luminance of the pixel; otherwise rendering a color value of the pixel on a corresponding pixel of the second image.

16. The device of claim 15, wherein a location of the code block or the unique chrominance of the code block is indicated in metadata associated with the first image.
